(19) United States
(12) Patent Application Publication
(10) Pub. No.: US 2017/0335663 A1
(43) Pub. Date: Nov. 23, 2017

(54) CONTROL SYSTEM FOR OPTIMIZING THE PLACEMENT OF PILLARS DURING A SUBTERRANEAN OPERATION

(71) Applicant: Halliburton Energy Services, Inc., Houston, TX (US)

(72) Inventors: Jason D. Dykstra, Spring, TX (US); Zhijie Sun, Spring, TX (US)

(73) Assignee: Halliburton Energy Services, Inc., Houston, TX (US)

(21) Appl. No.: 15/529,678

(22) PCT Filed: Dec. 29, 2014
(86) PCT No.: PCT/US14/72466

§ 371 Date: May 25, 2017

(51) Int. Cl. E21B 41/00; E21B 47/10; E21B 43/26; E21B 43/267; G05B 13/04; E21B 49/00

(52) U.S. Cl. CPC E21B 41/0092; G05B 13/041; E21B 49/00; E21B 43/26; E21B 43/267; E21B 47/10

(57) ABSTRACT

In accordance with some embodiments of the present disclosure, a control system for optimizing the placement of pillars during a subterranean operation is disclosed. The method includes determining a wave function from a generalized waveform equation and calculating a coefficient for at least one wave based on the wave function to create a total wave signal. The method additionally includes combining the total wave signal with a fracture system input to create a control signal. The method further includes sending the control signal to a fracturing equipment component to control a concentration of a proppant in a fracturing fluid during an injection treatment.

### TECHNICAL FIELD

The present disclosure relates generally to hydrocarbon recovery operations and, more particularly, to a control system for optimizing the placement of pillars during a subterranean operation.

### BACKGROUND

Natural resources, such as hydrocarbons and water, are commonly obtained from subterranean formations that may be located onshore or offshore. The development of subterranean operations and the processes involved in removing natural resources from a subterranean formation typically involve a number of different steps such as, for example, drilling a wellbore at a desired well site, treating the wellbore to optimize production of natural resources, and performing the necessary steps to produce and process the natural resources from the subterranean formation.

While performing subterranean operations, it is often desirable to fracture the formation to enhance the production of natural resources. In a hydraulic fracturing operation, a pressurized fracturing fluid may be used to create and propagate a fracture within the formation.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an elevation view of an example embodiment of a subterranean operations system used in an illustrative wellbore environment;

FIG. 2 illustrates an exemplary computing subsystem shown in FIG. 1;

FIG. 3 illustrates a proppant control system for a subterranean operation;

FIG. 4 illustrates a proppant control system using model-based conductivity analysis during a subterranean operation;

FIG. 5 illustrates an exemplary proppant concentration curve representing the concentration of proppant over time during a subterranean operation;

FIG. 6 illustrates a chart showing the relationship between the pressure in a fracture and a waveform parameter;

FIG. 7 illustrates a proppant control system using an extreme seeking analysis during a subterranean operation; and

FIG. 8 illustrates a proppant control system using a well-to-well control method during a subterranean operation.

### DETAILED DESCRIPTION

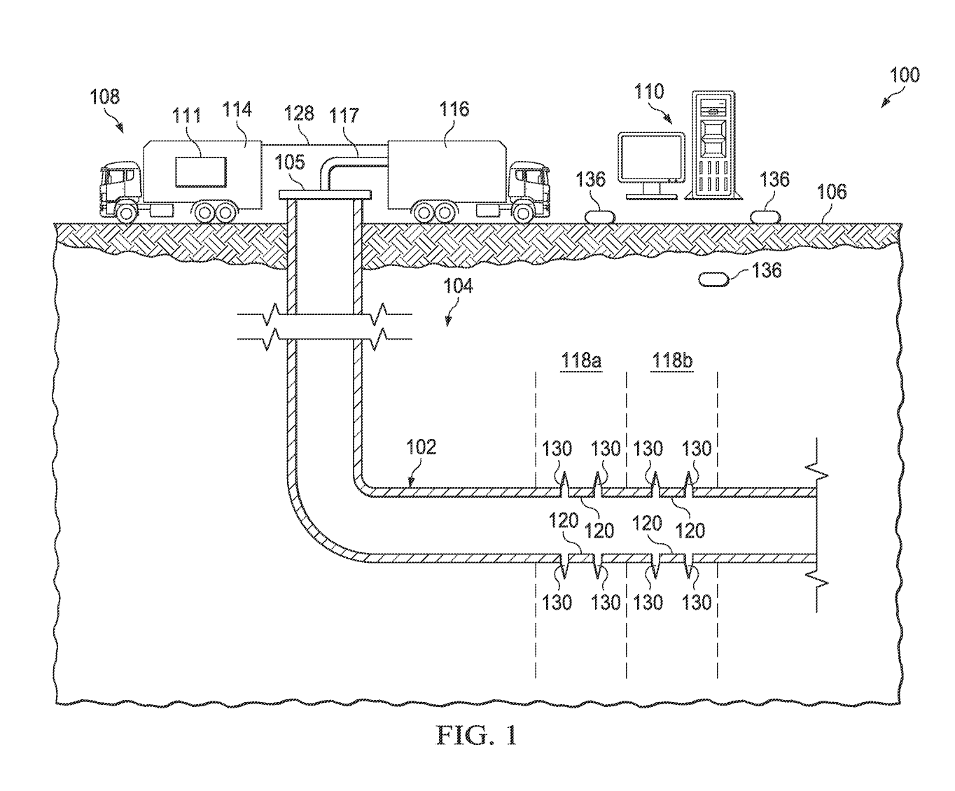

The present disclosure describes a control system for optimizing the placement of proppant pillars in a fracture during a subterranean operation. During the subterranean operation, fracturing fluid may be injected into a wellbore to create fractures in the subterranean formation in order to increase the rate of production of natural resources, such as hydrocarbons and water. The fracturing fluid may include solid material (e.g., proppant) that flows into the fractures and creates a packed mass that may prevent the closing of the fracture during the subterranean operation. The concentration of proppant in the fracturing fluid may vary during the subterranean operation, ranging from periods of higher proppant concentration to periods of lower proppant concentration. The variability of the proppant concentration may create pillars of proppant in the fractures with open space between each pillar. The pillars may hold the fracture open and allow flow of natural resources through the fracture. The size and placement of the pillars may be optimized by adjusting the proppant concentration of the fracturing fluid to create the highest flow rate through the fracture, while still serving to hold the fracture open. Accordingly, a system and method may be designed in accordance with the teachings of the present disclosure to optimize the proppant concentration of a fracturing fluid to result in a pillar placement that maximizes the production of natural resources from the wellbore, thus improving the efficiency of the subterranean operation. Embodiments of the present disclosure and their advantages are best understood by referring to FIGS. 1 through 8, where like numbers are used to indicate like and corresponding parts.

FIG. 1 illustrates an elevation view of an example embodiment of a subterranean operations system used in an illustrative wellbore environment. Well system 100 may include wellbore 102 in subterranean region 104 beneath ground surface 106. Wellbore 102, as shown in FIG. 1, may include a horizontal wellbore. However, a well system may include any combination of horizontal, vertical, slant, curved, or other wellbore orientations. Well system 100 may include one or more additional treatment wells, observation wells, or other types of wells. Subterranean region 104 may include a reservoir that contains natural resources, such as oil, natural gas, water, or others. For example, subterranean region 104 may include all or part of a rock formation (e.g., shale, coal, sandstone, granite, or others) that contains natural gas. Subterranean region 104 may include naturally fractured rock or natural rock formations that are not fractured to any significant degree. Subterranean region 104 may include tight gas formations of low permeability rock (e.g., shale, coal, or others).

Well system 100 may also include injection system 108. In some embodiments, injection system 108 may perform a treatment, for example, by injecting fluid into subterranean region 104 through wellbore 102. In some embodiments, a treatment fractures part of a rock formation or other materials in subterranean region 104. In such examples, fracturing a rock may increase the surface area of a formation, which may increase the rate at which the formation conducts hydrocarbon resources to wellbore 102.

Injection system 108 may be used to perform one or more treatments including, for example, injection treatments or flow back treatments. For example, injection system 108 may apply treatments including single-stage injection treatments, multi-stage injection treatments, mini-fracture test treatments, follow-on fracture treatments, re-fracture treatments, final fracture treatments, other types of fracture treatments, or any suitable combination of treatments. An injection treatment may be, for example, a multi-stage injection treatment where an individual injection treatment is performed during each stage. A treatment may be applied at a single fluid injection location or at multiple fluid injection locations in a subterranean region, and fluid may be injected over a single time period or over multiple different time periods. In some instances, a treatment may use multiple different fluid injection locations in a single wellbore, multiple fluid injection locations in multiple different wellbores, or any suitable combination. Moreover, a treatment may inject fluid through any suitable type of wellbore, such as, for example, vertical wellbores, slant wellbores, horizontal wellbores, curved wellbores, or any suitable combination of these and others.

Injection system 108 may inject treatment fluid into subterranean region 104 through wellbore 102. Injection system 108 may include instrument truck 114, pump truck 116, and injection treatment control subsystem 111. Injection system 108 may include other features not shown in the figures. Although FIG. 1 depicts a single instrument truck 114 and a single pump truck 116, any suitable number of instrument trucks 114 and pump trucks 116 may be used.

Pump trucks 116 may communicate treatment fluids into wellbore 102, for example, through conduit 117, at or near the level of ground surface 106. Pump trucks 116 may include mobile vehicles, immobile installations, skids, hoses, tubes, fluid tanks, fluid reservoirs, pumps, valves, mixers, or other types of structures and equipment. Pump trucks 116 may supply treatment fluid or other materials for a treatment. Pump trucks 116 may contain multiple different treatment fluids, proppant materials, or other materials for different stages of a treatment. Treatment fluids may be communicated through wellbore 102 from ground surface 106 level by a conduit installed in wellbore 102. The conduit may include casing cemented to the wall of wellbore 102. In some embodiments, all or a portion of wellbore 102 may be left open, without casing. The conduit may include a working string, coiled tubing, sectioned pipe, or other types of conduit.

Instrument trucks 114 may include injection treatment control subsystem 111, which controls or monitors the treatment applied by injection system 108. Instrument trucks 114 may include mobile vehicles, immobile installations, or other suitable structures. Injection treatment control subsystem 111 may control operation of injection system 108. Injection treatment control subsystem 111 may include data processing equipment, communication equipment, or other systems that control stimulation treatments applied to subterranean region 104 through wellbore 102. Injection treatment control subsystem 111 may include or be communicatively coupled to a computing system (e.g., computing subsystem 110) that calculates, selects, or optimizes treatment parameters for initialization, propagation, or opening fractures in subterranean region 104. Injection treatment control subsystem 111 may receive, generate or modify a stimulation treatment plan (e.g., a pumping schedule) that specifies properties of a treatment to be applied to subterranean region 104.

Injection system 108 may use multiple treatment stages or intervals, such as stage 118a and stage 118b (collectively “stages 118”). Injection system 108 may delineate fewer stages or multiple additional stages beyond the two exemplary stages 118 shown in FIG. 1. Stages 118 may each have one or more perforation clusters 120 that include one or more perforations. Fractures in subterranean region 104 may be initiated at or near perforation clusters 120 or elsewhere. Stages 118 may have different widths or may be uniformly distributed along wellbore 102. Stages 118 may be distinct, nonoverlapping (or overlapping) injection zones along wellbore 102. In some embodiments, each stage 118 may be isolated from other stages 118, for example, by packers or other types of seals in wellbore 102. In some embodiments, each stage 118 may be treated individually, for example, in series along wellbore 102. Injection system 108 may perform identical, similar, or different injection treatments at different stages 118.

A treatment, as well as other activities and natural phenomena, may generate microseismic events in subterranean region 104. Microseismic data may be collected from subterranean region 104. Microseismic data detected in well system 100 may include acoustic signals generated by natural phenomena, acoustic signals associated with a stimulation treatment applied through wellbore 102, or other types of signals. For instance, sensors 136 may detect acoustic signals generated by rock slips, rock movements, rock fractures or other events in subterranean region 104. Microseismic events in subterranean region 104 may occur, for example, along or near induced hydraulic fractures. Microseismic data from a stimulation treatment may include information collected before, during, or after fluid injection.

Wellbore 102 may include sensors 136, microseismic array, and other equipment that may be used to detect microseismic data. Sensors 136 may include geophones or other types of listening equipment. Sensors 136 may be located at a variety of positions in well system 100. As shown in FIG. 1, sensors 136 may be installed at surface 106 and beneath surface 106 (e.g., in an observation well (not shown)). Additionally or alternatively, sensors 136 may be positioned in other locations above or below ground surface 106, in other locations within wellbore 102, or within another wellbore (e.g., another treatment well or an observation well). Wellbore 102 may include additional equipment (e.g., working string, packers, casing, or other equipment) not shown in FIG. 1.

Sensors 136 or other detecting equipment in well system 100 may detect the microseismic events, and collect and transmit the microseismic data, for example, to computing subsystem 110. Computing subsystem 110 may be located above ground surface 106. Computing subsystem 110 may include one or more computing devices or systems located at the wellbore 102, or in other locations. Computing subsystem 110 or any of its components may be located apart from the other components shown in FIG. 1. For example, computing subsystem 110 may be located at a data processing center, a computing facility, or another suitable location. In some cases, all or part of computing subsystem 110 may be contained in a technical command center at a well site, in a real-time operations center at a remote location, in another appropriate location, or any suitable combination of these.

Well system 100 and computing subsystem 110 may include or access any suitable communication infrastructure. Communication links 128 may allow instrument trucks 114 to communicate with pump trucks 116, or other equipment at ground surface 106. Additional communication links may allow instrument trucks 114 to communicate with sensors or data collection apparatus in well system 100, remote systems, other well systems, equipment installed in wellbore 102 or other devices and equipment. For example, well system 100 may include multiple separate communication links or a network of interconnected communication links. These communication links may include wired or wireless communications systems. These communication links may include a public data network, a private data network, satellite links, dedicated communication channels, telecommunication links, or any suitable combination of these and other communication links. Computing subsystem 110 may be configured to perform additional or different operations. Computing subsystem 110 may perform, for example, operations to control the flow of fracturing fluid and/or proppant from injection system 108.

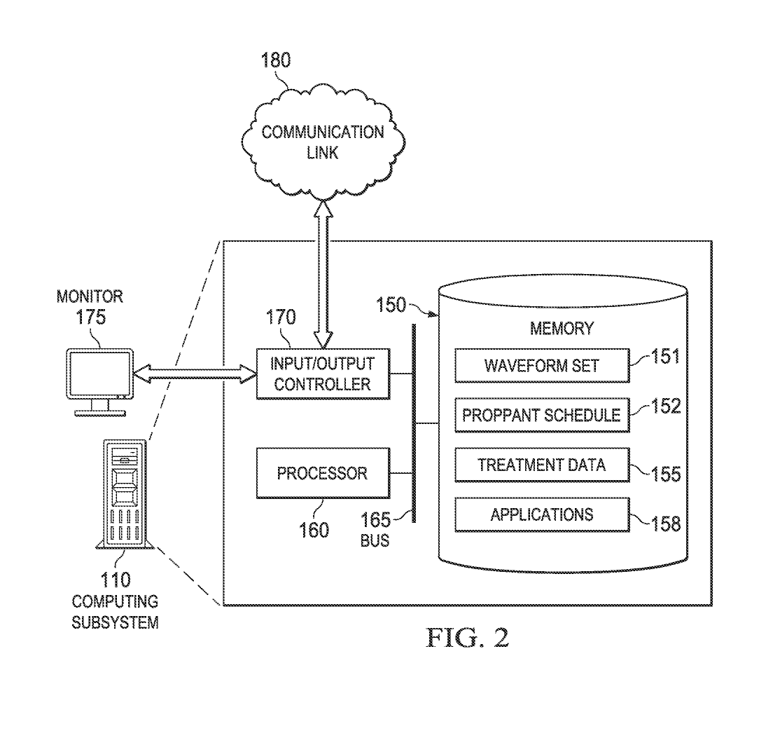

During a subterranean operation, formation 104 may be fractured to increase the production of natural resources (e.g., hydrocarbons or water) from formation 104. A high-pressure fracturing fluid may be pumped downhole and used to create fractures 130. The fracturing fluid may be a “clean fluid,” containing only liquid fracturing fluid, or may be a “sandy fluid,” containing a mixture of fracturing fluid and a proppant (e.g., treated sand or ceramic materials). When the proppant enters fracture 130, the proppant may form a packed mass in fracture 130. The packed mass may create a physical barrier that prevents fracture 130 from closing, however the packed mass may also reduce the flow of the natural resources from formation 104 into wellbore 102. Therefore, in some embodiments, the mixture pumped into wellbore 102 may include varying amounts of proppant. For example, the fracturing fluid may be pumped according to a schedule where clean fluid and sandy fluid may be alternatively pumped downhole. By alternating between a clean fluid and a sandy fluid, pillars of proppant may be created in fracture 130 which may hold fracture 130 open without reducing the flow of natural resources from formation 104. A control system may be used to control the amount of proppant in the fracturing fluid during a subterranean operation. As such, a control system designed according to the present disclosure may optimize the proppant concentration of the fracturing fluid to produce an optimal distribution of the proppant pillars in fracture 130, as discussed in further detail with respect to FIGS. 2-8.

Well system 100 may include additional or different features, and the features of well system 100 may be arranged as shown in FIG. 1, or in another suitable configuration. Some of the techniques and operations described here may be implemented by a computing subsystem configured to provide the functionality described. In various embodiments, a computing system may include any of various types of devices, including, but not limited to, personal computer systems, desktop computers, laptops, notebooks, mainframe computer systems, handheld computers, workstations, tablets, application servers, storage devices, computing clusters, or any type of computing or electronic device.

FIG. 2 illustrates an exemplary computing subsystem 110 of FIG. 1. Computing subsystem 110 may be located at or near one or more wellbores of well system 100 or at a remote location. All or part of computing subsystem 110 may operate as a component of or independent of well system 100 or independent of any other components shown in FIG. 1. Computing subsystem 110 may include memory 150, processor 160, and input/output controllers 170 communicatively coupled by bus 165.

Processor 160 may include hardware for executing instructions, such as those making up a computer program, such as application 158. As an example and not by way of limitation, to execute instructions, processor 160 may retrieve (or fetch) the instructions from an internal register, an internal cache, memory 150; decode and execute them; and then write one or more results to an internal register, an internal cache, memory 150. This disclosure contemplates processor 160 including any suitable number of any suitable internal registers, where appropriate. Where appropriate, processor 160 may include one or more arithmetic logic units (ALUs); be a multi-core processor; or include one or more processors 160. Although this disclosure describes and illustrates a particular processor, this disclosure contemplates any suitable processor.

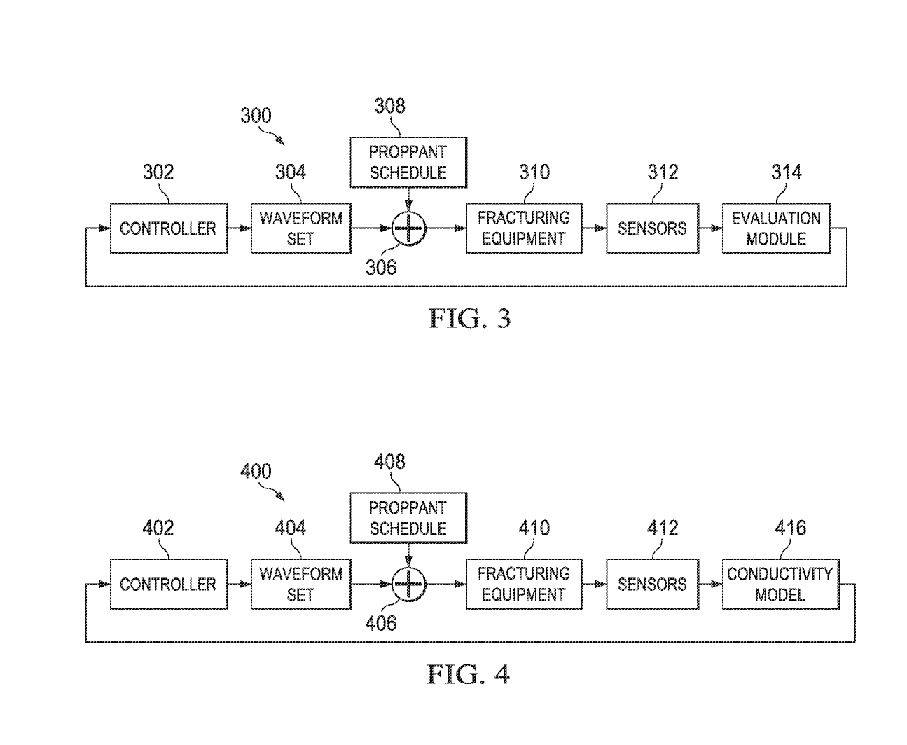

In some embodiments, processor 160 may execute instructions, for example, to generate output data based on data inputs. For example, processor 160 may run application 158 by executing or interpreting software, scripts, programs, functions, executables, or other modules contained in application 158. Processor 160 may perform one or more operations related to FIGS. 3-8. Input data received by processor 160 or output data generated by processor 160 may include waveform set 151 and proppant schedule 152.

Memory 150 may include, for example, random access memory (RAM), a storage device (e.g., a writable read-only memory (ROM) or others), a hard disk, a solid state storage device, or another type of storage medium. Computing subsystem 110 may be preprogrammed or it may be programmed (and reprogrammed) by loading a program from another source (e.g., from a CD-ROM, from another computer device through a data network, or in another manner). In some embodiments, input/output controller 170 may be coupled to input/output devices (e.g., monitor 175, a mouse, a keyboard, or other input/output devices) and to communication link 180. The input/output devices may receive and transmit data in analog or digital form over communication link 180.

Memory 150 may store instructions (e.g., computer code) associated with an operating system, computer applications, and other resources. Memory 150 may also store application data and data objects that may be interpreted by one or more applications or virtual machines running on computing subsystem 110. For example, waveform set 151, proppant schedule 152, and applications 158 may be stored in memory 150. In some implementations, a memory of a computing device may include additional or different data, applications, models, or other information.

Waveform set 151 may include information including a pre-determined set of proppant concentration waveforms for use in designing a control signal for an injection system (e.g., injection system 108 shown in FIG. 1). Waveform set 151 (e.g., waveform set 304, 404, or 804 shown in FIGS. 3, 4, and 8, respectively) may specify any suitable proppant concentration waveform that may be used for controlling the proppant concentration of fracturing fluid, such as a sinusoidal waveform, a square waveform, a sawtooth waveform, and/or a triangular waveform. Proppant schedule 152 may include information on the average amount of proppant available to input into the well during an injection operation. Processor 160 may create a wave signal using waveform set 151 and proppant schedule 152 to control the amount of proppant injected into the well at any point in time during the subterranean operation.

Treatment data 155 may include information on properties of a planned treatment of subterranean region 104. In some embodiments, treatment data 155 may include information on a pumping schedule for a treatment stage, such a fluid volume, fluid pumping rate, or fluid pumping pressure.

Applications 158 may include software applications, scripts, programs, functions, executables, or other modules that may be interpreted or executed by processor 160. The applications 158 may include machine-readable instructions for performing one or more operations related to FIGS. 3-8. Applications 158 may include machine-readable instructions for generating control signals for controlling the proppant concentration of a fracturing fluid during a subterranean operation. For example, applications 158 may include a proppant concentration control module to generate a control signal that may be sent to injection system 108 to control a valve on blending equipment included in the equipment used during a subterranean operation. Applications 158 may obtain input data, such as treatment data 155, proppant schedule 152, waveform set 151, or other types of input data, from memory 150, from another local source, or from one or more remote sources (e.g., via communication link 180). Applications 158 may generate output data and store output data in memory 150, in another local medium, or in one or more remote devices (e.g., by sending output data via communication link 180).

Communication link 180 may include any type of communication channel, connector, data communication network, or other link. For example, communication link 180 may include a wireless or a wired network, a Local Area Network (LAN), a Wide Area Network (WAN), a private network, a public network (such as the Internet), a WiFi network, a network that includes a satellite link, a serial link, a wireless link (e.g., infrared, radio frequency, or others), a parallel link, or another type of data communication network.

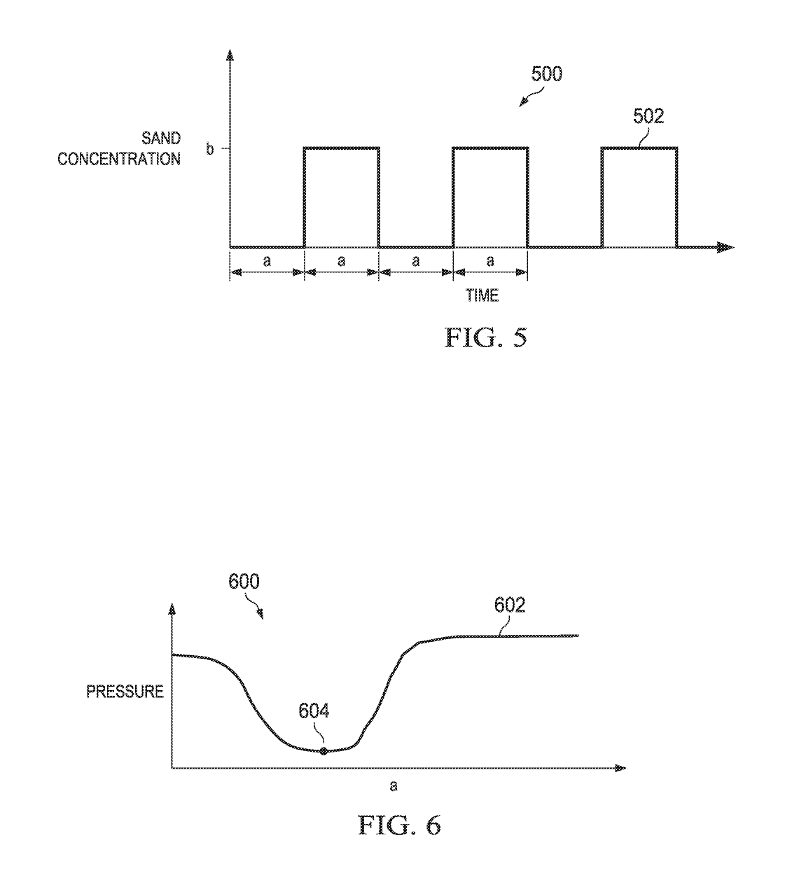

Generally, the techniques described here may be performed at any time, for example, before, during, or after a treatment or other event. In some instances, the techniques described may be implemented in real time, for example, during a stimulation treatment. Additionally, the techniques described may be performed by a computing subsystem located on the surface of the wellbore or may be located downhole as part of a downhole tool or drill string. FIG. 3 illustrates a proppant control system for a subterranean operation. Proppant control system 300 may include controller 302 and waveform set 304. Waveform set 304 may include a set of predefined waveforms that represent a variety of proppant concentration curves for the fracturing fluid pumped downhole into a wellbore (e.g., wellbore 102 shown in FIG. 1). Waveform set 304 may also be a generalized waveform equation that may be used to represent a waveform. A proppant concentration curve, as discussed in more detail with respect to FIG. 5, may represent the concentration of proppant included in the fracturing fluid during a treatment. For example, a proppant concentration curve may resemble a sinusoidal wave, where the concentration of proppant in the fracturing fluid gradually increases and decreases in a sinusoidal manner throughout the period of time fracturing fluid is pumped into the wellbore. Waveform set 304 may include any suitable waveform shape, such as a sinusoidal wave, a sawtooth wave, a triangular wave, or a square wave. Proppant control system 300 may include components similar to the components of computing subsystem 110 shown in FIG. 2.

The shape and characteristics of the proppant concentration curve may affect the size and spacing of the proppant pillars packed in the fractures of the formation (e.g., fractures 130 shown in FIG. 1). For example, if the proppant concentration is constant while the fracturing fluid is pumped into the wellbore, the proppant may be uniformly packed in the fracture. By varying the proppant concentration, proppant pillars may be formed. For example, when the proppant concentration is high, a proppant pillar may form in the fracture. When the proppant concentration is low, the fracture may fill with clean fluid. When the proppant concentration increases again in accordance with the proppant concentration curve, another proppant pillar may form in the fracture in the space behind the clean fluid.

Under ideal conditions, the fracturing fluid may remain in the fracture and none of the fracturing fluid may be lost to the formation (e.g., the fluid leak-off rate is essentially zero). When there is no fluid leak-off, the proppant distribution packed in the fracture may be similar to the waveform shape. For example, the size and spacing of the proppant columns may correlate to the proppant concentration of the fracturing fluid and the period of the waveform. However, under typical conditions in the wellbore, some fracturing fluid will leak out of the fracture and into the formation (e.g., the fluid leak-off rate is a non-zero value). The fluid leak-off rate may be a function of the permeability of the formation and may vary from well to well. Additionally, the fractures may have complex shapes that may affect the packing of proppant. Due to the shape of the fractures and the fluid leak-off rate, the pillars of proppant in the fracture may not correlate to the waveform shape and the pillars may be connected with one another and may reduce the flow of natural resources through the fracture. For example, if the fluid leak-off rate is high, the spacing between pillars may be reduced due to the fluid leaking into the formation while the proppant remains in the fracture.

To optimize the flow of natural resources (e.g., hydrocarbons or water) through the fracture, the spacing and/or size of the pillars of proppant may be controlled by controller 302. Controller 302 may select the waveform type and the characteristics of the waveform (e.g., amplitude and/or frequency) that results in the spacing and/or size of pillars that may create optimal flow through the fracture. Controller 302 may take into account the fluid leak-off rate and/or the shape of the fracture.

Controller 302 may use waveform set 304 to determine the optimal waveform shape and the characteristics of the waveform that may optimize the flow of fluid through the fractures. For example, controller 302 may determine the coefficients (e.g., the magnitude and frequency of each wave) and the wave function that represents the shape of the optimal waveform. The coefficients and wave functions may be summed together to determine the total wave signal that may be sent to the downhole equipment. The total wave signal may be expressed as

$$w ( t ) = {\sum }_{i = 1}^{N} {A}_{i} f ( i ω t ) \qquad ( 1 )$$

where ω is the lowest frequency of the waveforms, Aᵢ is the magnitude or amplitude of the waveform, and N is the total number of waveforms. The function ƒ(ωt) may be based on the waveform type (e.g., a sinusoidal wave, a sawtooth wave, a triangular wave, or a square wave).

Operator 306 may combine the total wave signal from controller 302 and waveform set 304 with proppant schedule 308 to generate a control signal. Proppant schedule 308 may be based on the average amount of proppant that is input into the wellbore during the subterranean operation. In some embodiments, proppant schedule 308 may be constant throughout the subterranean operation and the magnitude of the proppant concentration waveform may be limited based on the amount of proppant available as determined by proppant schedule 308. In some embodiments, controller 302 may also control proppant schedule 308 and may determine the optimal proppant schedule 308 that corresponds to the total wave signal, allowing controller 302 to vary the magnitude of the proppant concentration waveform without being limited by predetermined proppant schedule 308.

Once the total wave signal is combined with proppant schedule 308, the control signal may be sent to fracturing equipment 310. In some embodiments, fracturing equipment 310 may include blending equipment located at the surface (e.g., well surface 106 shown in FIG. 1), downhole, or a combination of both at the surface and downhole. In some embodiments, the blending equipment may include a valve or a sand screw that controls the amount of proppant added to the clean fracturing fluid. In other embodiments, the blending equipment may be pumps with changing rates or a downhole mixer with multiple flow lines. The control signal from operator 306 may be sent to the valve to change the position of the valve which, in return, changes the proppant concentration of the fracturing fluid. Once the fracturing fluid and proppant are blended, the mixture may be sent downhole during the subterranean operation.

While the fracturing fluid mixture is injected into the wellbore, sensors 312 may record measurements relating to the subterranean operation. Sensors 312 may be located at the surface, downhole, or a combination of both at the surface and downhole. The measurements may include any suitable measurements such as the surface pressure, the downhole pressure, and the proppant properties (e.g., concentration, density, viscosity, flow rate, or temperature of the proppant and/or the fracturing fluid). In some embodiments, sensors 312 may include microseismic monitoring equipment that may be used to determine the properties of the subterranean formation.

Measurements from sensors 312 may be sent to evaluation module 314 that translates the measurements into quality variables that may be used to determine the efficiency of the subterranean operation. For example, evaluation module 314 may correlate the measurements to a flow rate of natural resources through the fractures in the subterranean formation. The quality variables may be any suitable variable used to monitor the effectiveness of the subterranean operation and the efficiency of the production of natural resources, such as the total volume of natural resources produced, the flow rate of natural resources through the fracture, the size of the fracture, and/or the production rate of natural resources over time.

Evaluation module 314 may send the quality variables to controller 302 and controller 302 may adjust the total wave signal based on the effectiveness of the previous wave signal. In some embodiments, controller 302 may operate in real-time and control the wave signal of the proppant concentration curve throughout the subterranean operation, as discussed in further detail with respect to FIG. 5. In other embodiments, controller 302 may determine a total wave signal based on measurements from a previous subterranean operation. For example, controller 302 may base the total wave signal on the performance of another well operating in a similar environment (e.g., a similar type of rock formation or a similar subterranean operation).

FIG. 4 illustrates a proppant control system using model-based conductivity analysis during a subterranean operation. Proppant control system 400 may include controller 402 and waveform set 404, which may be similar to controller 302 and waveform set 304 shown in FIG. 3. Waveform set 404 may include a set of pre-defined waveforms that may represent the proppant concentration curve of the fracturing fluid pumped downhole into a wellbore. Waveform set 404 may include any suitable waveform shape, such as a sinusoidal wave, a sawtooth wave, a triangular wave, or a square wave.

Controller 402 may use waveform set 404 to determine the optimal waveform shape and the characteristics of the waveform that may optimize the pillar spacing and the flow of fluid through the fractures. Controller 402 may determine the coefficients (e.g., the magnitude and frequency of each wave) and the wave function that represents the shape of the optimal waveform and sum together to determine the total wave signal that may be sent to the downhole equipment.

Operator 406 may combine the total wave signal from controller 402 and waveform set 404 with proppant schedule 408 to generate a control signal. As described with respect to FIG. 3, in some embodiments, proppant schedule 408 may be constant throughout the subterranean operation and the magnitude of the proppant concentration waveform may be limited based on the amount of proppant available based on proppant schedule 408. In other embodiments, controller 402 may also control proppant schedule 408, allowing controller 402 to vary the magnitude of the proppant concentration waveform without being limited by proppant schedule 408.

Once the total wave signal is coupled with proppant schedule 408, the control signal may be sent to fracturing equipment 410 (e.g., blending equipment as described with respect to fracturing equipment 310 in FIG. 3). The fracturing fluid and proppant may be blended and sent downhole.

During the subterranean operation, sensors 412 may record measurements. Sensors 412 may be located at the surface, downhole, or a combination of both at the surface and downhole. The measurements may include any suitable measurements such as the surface pressure, the downhole pressure, and the proppant properties (e.g., concentration, density, viscosity, or flow rate). In some embodiments, sensors 412 may include microseismic monitoring equipment that may be used to determine the properties of the subterranean formation. In other embodiments, sensors 412 may include downhole optical fiber sensors that may measure a downhole acoustic vibration signal that may be used to determine the downhole flow rate of the fracturing fluid entering each fracture.

Measurements from sensors 412 may be sent to conductivity model 416. Conductivity model 416 may use the measurements from sensors 412 to determine the conductivity of the fracture in real-time. The conductivity of the fracture may be a measure of how easily natural resources move through the fracture. The conductivity of the fracture may be expressed by any suitable variable. For example, the flow capacity of the fracture may be a product of the fracture permeability and the width of the fracture. Conductivity model 416 may use the measurements (e.g., surface pressure, downhole pressure, and/or microseismic measurements) to estimate the volume and shape of the fracture and the distribution of the pillars. Conductivity model 416 may also determine the optimal distribution of the pillars that have the ability to support the weight of the formation, while still holding the fracture open. In some embodiments, the optimal distribution may be based on determining how much flexing of the formation occurs between each pillar and conductivity model 416 may space the pillars such that the formation does not flex by an amount sufficient to close the fracture. In some embodiments, where sensors 412 include downhole optical fiber sensors, the friction created by the presence of the proppant pillars may be estimated using measurements from sensors 412.

Conductivity model 416 may be created prior to the start of the subterranean operation, based on data known about the subterranean formation, the wellbore, and/or any other suitable information about the subterranean operation. In some embodiments, conductivity model 416 may be updated during the subterranean operation, based on the data recorded by sensors 412 and/or information on how the fracturing fluid is flowing through the fractures.

The fracture conductivity calculated by conductivity model 416 may be sent to controller 402 and controller 402 may adjust the total wave signal. For example, if the fracture conductivity decreases, controller 402 may adjust the total wave signal to change the spacing and/or size of the proppant pillars to increase the fracture conductivity. Controller 402 may adjust the total wave signal in real-time to maximize the fracture conductivity, as calculated by conductivity model 416.

FIG. 5 illustrates an exemplary proppant concentration curve representing the concentration of proppant over time during a subterranean operation. Proppant concentration curve 502 may represent the total wave signal, as calculated by Equation 1 described with respect to FIG. 3. The total wave signal may have any suitable shape. For example, in FIG. 5, proppant concentration curve 502 is a square wave. In other embodiments, proppant concentration curve 502 may be a sinusoidal wave, a sawtooth wave, or triangular wave.

The function ƒ(ωt), in Equation 1, may be based on the waveform type. For example, if the waveform is sinusoidal, ƒ(ωt)=sin ωt. For sinusoidal waves, based Fourier series theory, if N is infinitely large, then virtually all waveforms may be represented by Equation 1. In embodiments where the wave function, ƒ(ωt), is well defined, the total number of waveforms may be reduced. For example, the total wave signal shown in FIG. 5 may be represented by

w(t)=ƒ_{sq}(a,b) (2)

where a and b are parameters of the wave signal, as shown in FIG. 5. As parameter a is reduced, the distance between the proppant pillars will decrease. Depending on the fluid leak-off rate, the space between proppant pillars may be reduced to zero, where the pillars are connected to one another, reducing the flow of natural resources through the fracture. As parameter a is increased, the size of the proppant pillars will increase. Eventually, parameter a may be so large as to create pillars having a diameter that impedes the flow of natural resources through the fracture and decreases the effectiveness of the subterranean operation. Additionally, as parameter a is increased, the space between the proppant pillars will also increase. Due to the rock stress, the fracture plane (e.g., the rock surface) may bend towards the void space created by fracture. The cross sectional area of the fracture may then decrease and thus reduce the capability of the fracture to carrying flows of natural resources.

A controller (e.g., controller 302 shown in FIG. 3) may determine the optimal values for parameters a and b as described in further detail with respect to FIG. 6. The controller may optimize a total wave signal and may output the total wave signal, couple the total wave signal with the proppant schedule (e.g., proppant schedule 308 shown in FIG. 3), and send the resulting signal to the fracturing equipment (e.g., fracturing equipment 310 shown in FIG. 3).

FIG. 6 illustrates a chart showing the relationship between the pressure in a fracture and a waveform parameter. The conductivity of natural resources through a fracture may be directly related to the pressure in the fracture (e.g., the lower the pressure in the fracture, the higher the fracture conductivity). The pressure-frequency relationship may be charted to create graph 600 and may be based on the length and width of the fracture. Curve 602 may represent the pressure versus a parameter related to the frequency of the proppant waveform. In FIG. 6, the parameter is parameter a, shown in FIG. 5. FIG. 6 illustrates that when parameter a is a small number, the pressure in the fracture is high, corresponding to conditions in the fracture where the proppant pillars are connected and the flow through the fracture is low. As parameter a increases, the pressure decreases and the flow through the fracture increases until the pressure in the fracture is at the lowest point on curve 602, corresponding to the optimal value of parameter a (e.g., point 604 in FIG. 6). After the optimal value of parameter a, as parameter a further increases, corresponding to an increase in the size (e.g., radius) of the proppant pillars, the pressure in the fracture increases and the flow through the fracture decreases.

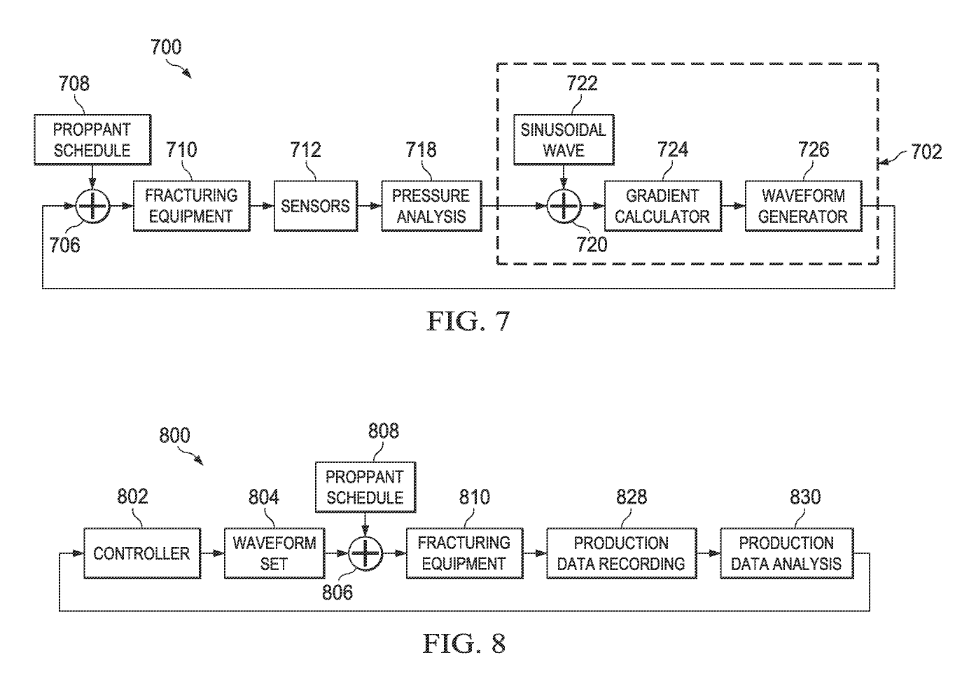

A controller may be designed to determine the optimal parameters of a waveform, based on the pressure-frequency relationship using an extreme seeking analysis. FIG. 7 illustrates a proppant control system using an extreme seeking analysis during a subterranean operation. Proppant control system 700 may include controller 702. Controller 702 may be designed to find the optimal parameters for a waveform, such as the square wave shown in FIG. 5, by seeking the extreme of the pressure-frequency relationship (e.g., point 604 shown in FIG. 6). The technique used by controller 702 may involve adding, at operator 720, sinusoidal signal 722 to the inferred fracture conductivity, as determined by the pressure analysis performed at block 718. Sinusoidal signal 722 may be a small signal of the form c sin ωt, where c is a small number. Gradient calculator 724 may use the output of operator 720 to adjust the value of parameter a to adjust parameter a such that the pressure in the fracture is decreased. Gradient calculator 724 may include filters (e.g., a high pass filter and/or a low pass filter) to condition sinusoidal signal 722.

In some embodiments, the value of parameter b, as shown in FIG. 5, may be determined based on proppant schedule 708 by matching the value of parameter b to the total proppant amount in proppant schedule 708. The values of parameters a and b may be sent to waveform generator 726 to create a total wave signal to send to operator 706 where the total wave signal may be combined with proppant schedule 708 to generate a control signal.

Once the total wave signal is coupled with proppant schedule 708, the control signal may be sent to fracturing equipment 710 including one or more pieces of blending equipment. The fracturing fluid and proppant may be blended and sent downhole.

During the subterranean operation, sensors 712 may record measurements. Sensors 712 may be located at the surface, downhole, or a combination of both at the surface and downhole. The measurements may include any suitable measurements such as the surface pressure, the downhole pressure, and the proppant properties (e.g., concentration, density, viscosity, or flow rate). In some embodiments, sensors 712 may include microseismic monitoring equipment that may be used to determine the properties of the subterranean formation.

Measurements from sensors 712 may be sent to block 718 where pressure analysis may be performed to determine the conductivity in the fracture based on the pressure in the fracture. The conductivity may be sent to controller 702 and used to determine the total wave signal. Controller 702 may operate in real-time during a subterranean operation and may adjust the total wave signal based on pressure analysis performed at block 718.

In some subterranean operations, real-time control may not be feasible due the limitations of the subterranean operation (e.g., the computing requirements for performing real-time control). FIG. 8 illustrates a proppant control system using a well-to-well control method during a subterranean operation. Proppant control system 800 may include elements similar to control system 300 shown in FIG. 3 including controller 802 and waveform set 804. Controller 802 may use waveform set 804 to determine the optimal waveform shape and the characteristics of the waveform that may optimize the flow of natural resources through the fractures. The total wave signal may be combined with proppant schedule 808 at operator 806 to generate a control signal. The control signal from operator 806 may be sent to fracturing equipment 810 where the control signal may control blending equipment that may blend the fracturing fluid and proppant and send the mixture downhole.

During the subterranean operation, surface and/or downhole measurements may not be available. However, information about the production from the well may be recorded at block 828. The recorded production data may include any suitable production data, such as the production rate from the well over time. The production data may be analyzed in block 830 to correlate with the production data with the fracture conductivity.

Controller 802 may determine the waveform shape and waveform coefficients based on the production data analysis. For example, controller 802 may determine the waveform shape and waveform coefficients that may produce the largest possible fracture conductivity. The production data analysis may use data from a previous subterranean operation with the resulting production data from the previous well or may use data from the current subterranean operation and the current well.

Embodiments disclosed herein include:

A. A method of optimizing placement of proppant pillars in a fracture including determining a wave function from a generalized waveform equation, calculating a coefficient for at least one wave based on the wave function to create a total wave signal, combining the total wave signal with a fracture system input to create a control signal, and sending the control signal to a fracturing equipment component to control a concentration of a proppant in a fracturing fluid during an injection treatment.

B. A proppant concentration control system including a processor, a memory communicatively coupled to the processor, and a proppant concentration control module. The proppant concentration control module may be executing on the processor and operable to determine a wave function from a generalized waveform equation, calculate a coefficient for at least one wave based on the wave function to create a total wave signal, combine the total wave signal with a fracture system input to create a control signal, and send the control signal to a fracturing equipment component to control a concentration of a proppant in a fracturing fluid during an injection treatment.

C. A non-transitory machine-readable medium comprising instructions stored therein and executable by one or more processors to facilitate performing a method of forming a wellbore. The method includes determining a wave function from a generalized waveform equation, calculating a coefficient for at least one wave based on the wave function to create a total wave signal, combining the total wave signal with a fracture system input to create a control signal, and sending the control signal to a fracturing equipment component to control a concentration of a proppant in a fracturing fluid during an injection treatment.

Each of embodiments A, B, and C may have one or more of the following additional elements in any combination: Element 1: further including recording a measurement of a condition in a wellbore during the injection treatment, determining whether to update the control signal based on the measurement, and calculating, based on the determination, an updated total wave signal. Element 2: further including recording a measurement in a wellbore, determining a frictional force in a fracture based on a model, the model correlating the measurement with the frictional force, determining whether to update the control signal based on the frictional force, and calculating, based on the determination, an updated total wave signal. Element 3: wherein calculating the coefficient is based on production data from a wellbore. Element 4: wherein calculating the coefficient is based on a fluid leak-off rate of a subterranean formation. Element 5: wherein calculating the coefficient is based on at least one of a spacing and a size of a plurality of pillars in a fracture. Element 6: wherein calculating the coefficient is performed in real-time during a subterranean operation. Element 7: wherein calculating the coefficient for the at least one wave further includes calculating a coefficient for each wave of a plurality of waves based on the wave function and summing each wave of the plurality of waves to calculate a total wave signal. Element 8: further comprising mixing a mixture of the proppant and the fracturing fluid based on the control signal and pumping the mixture into a wellbore.

Although the present disclosure and its advantages have been described in detail, it should be understood that various changes, substitutions and alterations can be made herein without departing from the spirit and scope of the disclosure as defined by the following claims. It is intended that the present disclosure encompasses such changes and modifications as fall within the scope of the appended claims.

What is claimed is:

1. A method of optimizing placement of proppant pillars in a fracture, comprising:
determining a wave function from a generalized waveform equation;
calculating a coefficient for at least one wave based on the wave function to create a total wave signal;
combining the total wave signal with a fracture system input to create a control signal; and
sending the control signal to a fracturing equipment component to control a concentration of a proppant in a fracturing fluid during an injection treatment.

2. The method of claim 1, further comprising:
recording a measurement of a condition in a wellbore during the injection treatment;
determining whether to update the control signal based on the measurement; and
calculating, based on the determination, an updated total wave signal.

3. The method of claim 1, further comprising:
recording a measurement in a wellbore;
determining a frictional force in a fracture based on a model, the model correlating the measurement with the frictional force;
determining whether to update the control signal based on the frictional force; and
calculating, based on the determination, an updated total wave signal.

4. The method of claim 1, wherein calculating the coefficient is based on production data from a wellbore.

5. The method of claim 1, wherein calculating the coefficient is based on a fluid leak-off rate of a subterranean formation.

6. The method of claim 1, wherein calculating the coefficient is based on at least one of a spacing and a size of a plurality of pillars in a fracture.

7. The method of claim 1, wherein calculating the coefficient is performed in real-time during a subterranean operation.

8. The method of claim 1, wherein calculating the coefficient for the at least one wave further includes:
calculating a coefficient for each wave of a plurality of waves based on the wave function; and
summing each wave of the plurality of waves to calculate a total wave signal.

9. The method of claim 1, further comprising:
mixing a mixture of the proppant and the fracturing fluid based on the control signal; and
pumping the mixture into a wellbore.

10. A proppant concentration control system, comprising:
a processor;
a memory communicatively coupled to the processor; and
a proppant concentration control module executing on the processor and operable to:
determine a wave function from a generalized waveform equation;
calculate a coefficient for at least one wave based on the wave function to create a total wave signal;
combine the total wave signal with a fracture system input to create a control signal; and
send the control signal to a fracturing equipment component to control a concentration of a proppant in a fracturing fluid during an injection treatment.

11. The system of claim 10, the proppant concentration control module further operable to:
record a measurement of a condition in a wellbore during the injection treatment; and
determine whether to update the control signal based on the measurement; and
calculate, based on the determination, an updated total wave signal.

12. The system of claim 10, the proppant concentration control module further operable to:
record a measurement in a wellbore;
determine a frictional force in a fracture based on a model, the model correlating the measurement with the frictional force;
determine whether to update the control signal based on the frictional force; and
calculate, based on the determination, an updated total wave signal.

13. The system of claim 10, wherein calculating the coefficient is based on production data from a wellbore.

14. The system of claim 10, wherein calculating the coefficient is based on a fluid leak-off rate of a subterranean formation.

15. The system of claim 10, wherein calculating the coefficient is based on at least one of a spacing and a size of a plurality of pillars in a fracture.

16. A non-transitory machine-readable medium comprising instructions stored therein, the instructions executable by one or more processors to facilitate performing a method of forming a wellbore, the method comprising:
determining a wave function from a generalized waveform equation;
calculating a coefficient for at least one wave based on the wave function to create a total wave signal;
combining the total wave signal with a fracture system input to create a control signal; and
sending the control signal to a fracturing equipment component to control a concentration of a proppant in a fracturing fluid during an injection treatment.

17. The non-transitory machine-readable medium of claim 16, wherein the method further comprises:
recording a measurement of a condition in a wellbore during the injection treatment; and
determining whether to update the control signal based on the measurement; and
calculating, based on the determination, an updated total wave signal.

18. The non-transitory machine-readable medium of claim 16, wherein the method further comprises:
recording a measurement in a wellbore;
determining a frictional force in a fracture based on a model, the model correlating the measurement with the frictional force;
determining whether to update the control signal based on the frictional force; and
calculating, based on the determination, an updated total wave signal.

19. The non-transitory machine-readable medium of claim 16, wherein calculating the coefficient is based on production data from a wellbore.

20. The non-transitory machine-readable medium of claim 16, wherein calculating the coefficient is based on a fluid leak-off rate of a subterranean formation.

21. The non-transitory machine-readable medium of claim 16, wherein calculating the coefficient is based on at least one of a spacing and a size of a plurality of pillars in a fracture.
